(19) United States
(12) Patent Application Publication
(10) Pub. No.: US 2005/0199647 A1
(43) Pub. Date: Sep. 15, 2005

(54) Automatic feeding device for syringes and saline water cartridge of radiopharmaceuticals dispensing and injection system

(76) Inventors: Akio Muto, Shonandai Fujisawa-City (JP); Chi-Min Hu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/044,175

(22) Filed: Jan. 28, 2005

(30) Foreign Application Priority Data
Feb. 6, 2004 (TW) 93102752

(51) Int. Cl. B67D 5/08; B67D 5/14

(52) U.S. Cl. 222/52

(57) ABSTRACT

Disclosed is an automatic feeding device for syringes and saline water cartridges of a radiopharmaceuticals dispensing and injection system, including a syringe supply module, which includes a plurality of disposable syringes arranged in a line for feeding one disposable syringe at each time under the control of a syringe feeding mechanism. A saline water cartridge module includes a plurality of saline water cartridges arranged in a line, and feeding one saline water cartridge at each time under the control of a saline water cartridge feeding mechanism. A movable dispensing and injection mechanism clamps the disposable syringe fed by the syringe feeding mechanism and performs radiopharmaceuticals withdrawal/dispensing operation at a dispensing position to withdraw radiopharmaceuticals from a vial, and moving the disposable syringe from the dispensing position to an injection position and injecting the withdrawn radiopharmaceuticals into the saline water cartridge fed by the saline water cartridge feeding mechanism at the injection position. A disposable insertion assembly is inserted through an injection needle insertion hole into a radiopharmaceuticals discharge end of the saline water cartridge to discharge the saline water and the radiopharmaceuticals inside the saline water cartridge through the radiopharmaceuticals discharge end.

### FIELD OF THE INVENTION

The present invention relates generally to a medicine dispensing and injection system, and in particular to radiation-shielded dispensing and injection system for radiopharmaceuticals.

### BACKGROUND OF THE INVENTION

Due to the unique invivo imaging capability, positron emission tomography (PET) has been recently used in early detection and treatment of cancers that could not be detected previously. This makes PET one of most important measures for diagnosis of a variety of tumors, as well as the main stream of future nuclear medicine

Positron radio-nuclides (radiopharmaceuticals) for PET are generated in a cyclotron, which are then composed with other elements to form compound/molecules, such as glucose, amino acid, and water by radio-chemist and conveyed to injection room for injection into human body by medical employees in order to carry out PET diagnosis by doctors. The positrons are annihilated with electrons inside the human body, which emits gamma rays running in opposite directions, which can be detected by PET and, after been processed by a computer system for imaging, provides functional images and parameters for diagnosis.

The PET facility is of great help for medical diagnosis, but the positron radionuclides of the PET give off strong radiation. Thus, it is a major challenge to protect the radio-chemists and medical employees from over-exposure to radiation.

During the PET process, the radio-chemists, doctors, nurses, and medical assistants must do quantity measurement, quality control, dispensing, conveyance, and injection of the radiopharmaceuticals. If they are not properly protected from radiation, then their health is subject to serious hazard.

Currently, in order to effect radiation protection of the radio-chemists, doctors, nurses, and medical assistants, who are subject to exposure to radiation in every handling process, emphasis is placed on the design of radiation shielding, such as radiation-shielded spaces, syringes having radiation-shielding function, conveyance carrier that is radiation shielded, and the likes to effect radiation protection for medical employees.

To solve the problem, a system comprising a tube connecting between dispensing equipment and injection equipment is available. However, such a system cannot prevent back flow of a patient's blood through the tube into the injection system.

However, the known techniques that place emphasis on the design of radiation shielding for protecting medical employees from exposure to radiation are insufficient to effect perfect radiation protection. Automatized control of the related assembly and components plays an important role is solving the problem. For example, inside a radiation-shielded chamber, if there is no way to automatize the feeding, conveyance, injection, and flushing of syringes, the operation of the whole facility is very inconvenient.

In addition, automatic control and automatic feeding cannot be effected, the operation must be done manually by the operators, which still causes risk of radiation exposure to the operators even the radiation shielding of the radiation-shielded is made perfect.

Further, after the injection of radiopharmaceuticals, the used syringe, empty saline water cartridge, syringe needle, and tube, if not processed properly, may still cause radiation exposure of the medical employees. These components and parts must be disposed of properly. However, it is difficult to effect both excellent radiation protection and proper disposal of the wastes in a radiation-shielded facility. The prior art provides no solution for such a problem.

Thus, it is desired to provide automatic radiopharmaceuticals injection system for solving the problems discussed above.

### SUMMARY OF THE INVENTION

A primary objective of the present invention is to provide an automatic feeding device for syringes and saline water cartridges of a radiopharmaceuticals injection system, whereby desired syringe and saline water cartridge can be fed to a predetermined position in an automatic feeding manner by means of the automatic feeding mechanism of the present invention.

Another objective of the present invention is to provide an automatic syringe and saline water cartridge feeding device that automatically performs radiopharmaceuticals dispensing, withdrawal, conveyance, and injection whereby automatic feeding of syringes and saline water cartridges without manual operation can be realized by means of control performed by the automatized mechanism in accordance with the present invention, which reduces radiation exposure of operators and effects excellent radiation protection.

A further object of the present invention is to provide an automatic feeding device, which operates with disposable syringes and saline water cartridges to eliminate facility contamination caused by back flow of patient blood, wherein the used syringes and saline water cartridges are all disposed of after the injection equipment of the present invention completes injection of radiopharmaceuticals thereby completely eliminating the problem of back flow of patient blood to the vial and the device.

The solution of the present invention to overcome the problems of the prior art is that inside a chamber of a radiopharmaceuticals injection system, a syringe supply module is arranged, which comprises a plurality of disposable syringes arranged in a line for feeding one disposable syringe at each time under the control of a syringe feeding mechanism. A saline water cartridge module comprises a plurality of saline water cartridges arranged in a line, and feeding one saline water cartridge at each time under the control of a saline water cartridge feeding mechanism. A movable dispensing and injection mechanism clamps the disposable syringe fed by the syringe feeding mechanism and performs radiopharmaceuticals withdrawal/dispensing operation at a dispensing position to withdraw radiopharmaceuticals from a vial, and moving the disposable syringe from the dispensing position to an injection position and injecting the withdrawn radiopharmaceuticals into the saline water cartridge fed by the saline water cartridge feeding mechanism at the injection position. A disposable insertion assembly is inserted through an injection needle insertion hole into a radiopharmaceuticals discharge end of the saline water cartridge to discharge the saline water and the radiopharmaceuticals inside the saline water cartridge through the radiopharmaceuticals discharge end.

Thus, compared to the prior art, the present invention provides an automatic feeding mechanism, which, when applied in a radiopharmaceuticals injection system, automatically feeds desired syringes and saline water cartridges in a chamber. All the operations of radiopharmaceuticals dispensing, withdrawal, conveyance, and injection can be controlled by the automatic mechanism of the present invention without manual operation, thereby effectively reducing the risk of radiation exposure of the medical employees. Further, the present invention combines the automatic feeding device with disposable syringes and saline water cartridges to effectively eliminate -facility contamination caused by back flow of patient blood.

### BRIEF DESCRIPTION OF THE DRAWINGS

The present invention will be apparent to those skilled in the art by reading the following description of a preferred embodiment thereof, with reference to the attached drawings, in which:

FIG. 1 a perspective view of an automatic feeding device for syringes and saline water cartridges in accordance with the present invention;

FIG. 2 is a front-side perspective view, illustrating a radiation-shielded radiopharmaceuticals withdrawal and injection system to which the automatic feeding device for syringes and saline water cartridges of the present invention is incorporated;

FIG. 3 is an enlarged partial perspective view, illustrating the condition when a vial shown in FIG. 2 is handled by a robotic manipulating clamp to move into a dosage calibration container and the dosage calibration container, together with the vial, is moved into a dosage calibrator;

FIG. 4 is an enlarged partial perspective view, illustrating the condition when the vial is moved into a vial container after the dosage calibration performed in FIG. 3;

FIG. 5 is an enlarged partial perspective view, illustrating the arrangement among a disposable syringe module, a movable dispensing and injection mechanism, and the vial container;

FIG. 6 is an enlarged partial perspective view, illustrating the condition when a disposable syringe is held by a pick-up arm but a needle atop the syringe does not penetrate into a bottom of the vial yet;

FIG. 7 is an enlarged partial perspective view, illustrating the condition when the disposable syringe is held by the pick-up arm and the needle atop the syringe penetrates into the bottom of the vial, but a plunger of the disposable syringe is not pulled downward yet;

FIG. 8 is an enlarged partial perspective view, illustrating the condition when the disposable syringe is held by the pick-up arm, the needle atop the syringe penetrates into the bottom of the vial, and the plunger of the disposable syringe is pulled downward;

FIG. 9 is a cross-sectional view of a two-open-end structure of the vial employed in the present invention;

FIG. 10 is an enlarged partial perspective view, illustrating the condition when the disposable syringe is moved to an injection position but the syringe needle does not penetrate into a radiopharmaceuticals injection end of a saline water cartridge yet;

FIG. 11 is an enlarged partial perspective view, illustrating the condition when the disposable syringe is moved to an injection position and the syringe needle penetrates into the radiopharmaceuticals injection end of the saline water cartridge;

FIG. 12 is an enlarged partial perspective view, illustrating the condition when the disposable syringe is moved to an injection position, the syringe needle penetrates into the radiopharmaceuticals injection end of the saline water cartridge, and the syringe plunger is pushed upward;

FIG. 13 is a cross-sectional view, illustrating the condition when the needle of the disposable syringe penetrates into the radiopharmaceuticals injection end of the saline water cartridge and the plunger is pushed upward;

FIG. 14 is a cross-sectional view, illustrating the condition when the needle of the disposable syringe penetrates into the radiopharmaceuticals injection end of the saline water cartridge and the plunger is pulled downward;

FIG. 15 is a partial perspective view of a syringe feeding mechanism of a syringe supply module in accordance with the present invention;

FIG. 16 is a cross-sectional view of a saline water cartridge feeding mechanism of a saline water cartridge module in accordance with the present invention; and

FIG. 17 is a perspective view, illustrating the condition that the present invention disposes of the used disposable syringe, together with the used saline water cartridges, a portion of a tube, and a disposable insertion assembly.

### DETAILED DESCRIPTION OF THE PREFERRED EMBODIMENTS

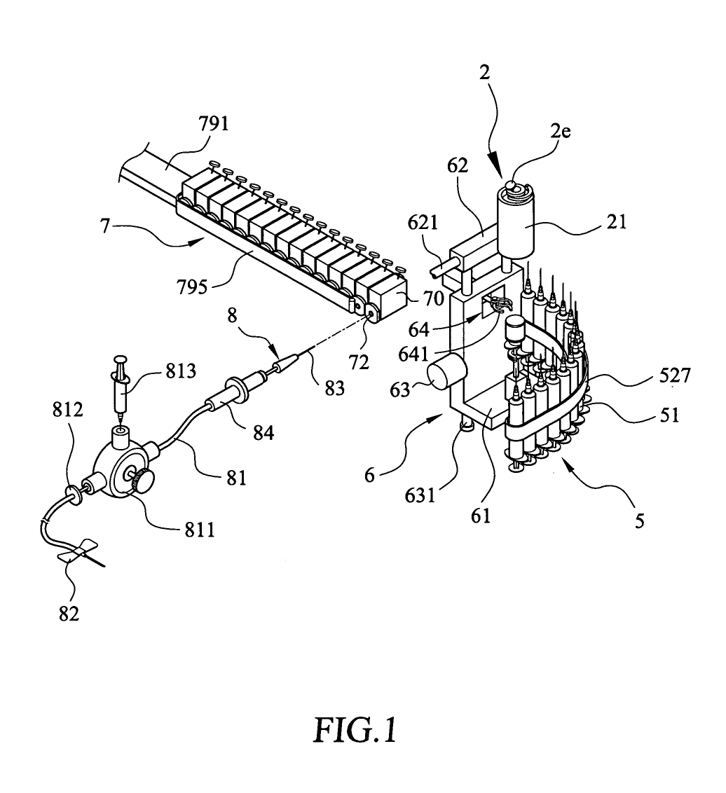

With reference to FIG. 1, which shows a perspective view of an automatic feeding device for syringes and saline water cartridges in accordance with the present invention, the automatic feeding device for syringes and saline water cartridges in accordance with the present invention is arranged inside a chamber, comprising a syringe supply module 5, a movable dispensing and injection mechanism 6, and a saline water cartridge module 7.

The syringe supply module 5 comprises a plurality of disposable syringes 51 arranged in a line. The saline water cartridge module 7 comprises a plurality of saline water cartridges 70 arranged in a line. Under the control of the movable dispensing and injection mechanism 6, one of the disposable syringes 51 is selected from the syringe supply module 5 and radiopharmaceuticals is withdrawn from a vial 2 for dispensing of the radiopharmaceuticals. After the dispensing operation, the vial 2 is moved to a predetermined injection position to inject the radiopharmaceuticals into a selected one of the saline water cartridges 70. Then, the disposable syringe 51 and the saline water cartridge 70 that have been used are disposed of.

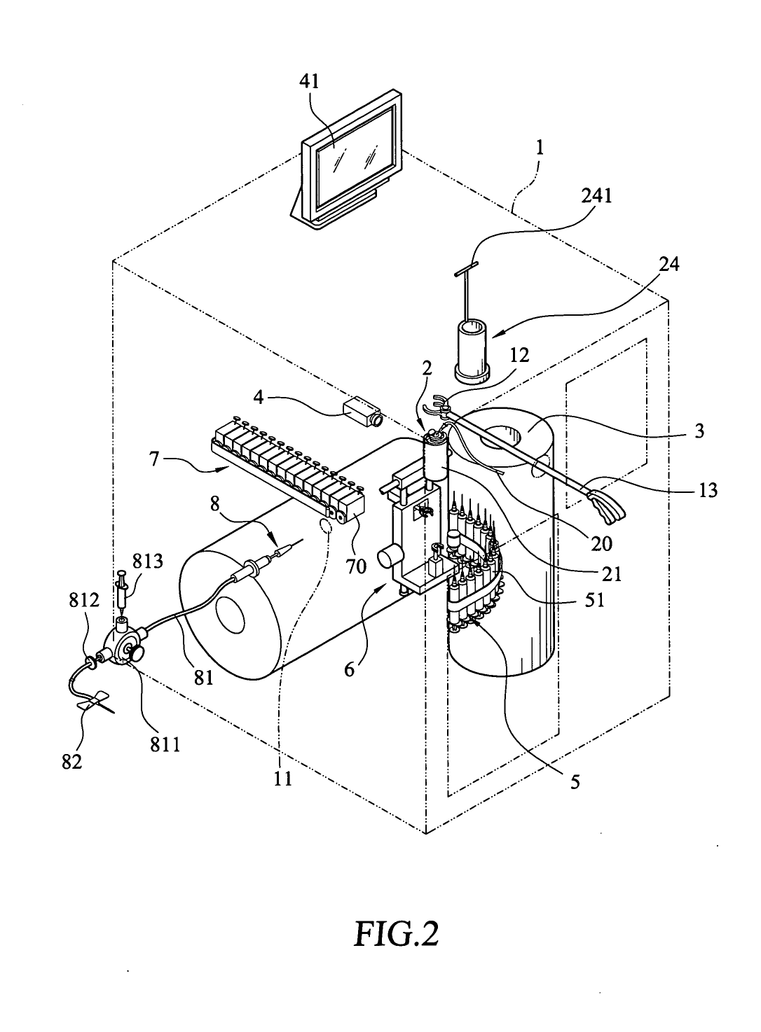

Referring to FIG. 2, which shows a front-side perspective view of a radiation-shielded radiopharmaceuticals withdrawal and injection system into which the automatic syringe and saline water cartridge feeding device of the present invention is incorporated, as shown in the drawing, the radiation-shielded radiopharmaceuticals withdrawal and injection system generally comprises a radiation-shielded hermetic chamber 1, which is made of materials having radiation-shielding function, such as lead and tungsten. The radiation-shielded hermetic chamber 1 provides a closed, radiation-shielded interior space, and the hermetic chamber is provided with at least one injection needle insertion hole 11.

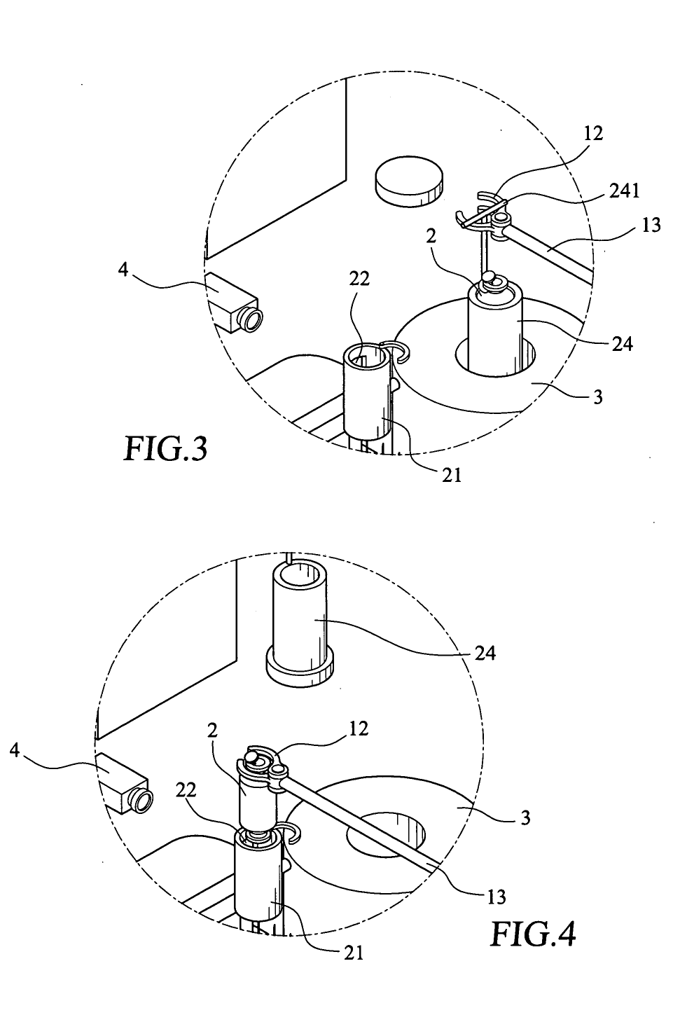

The radiation-shielded hermetic chamber 1 receives a vial 2 (also referring to FIGS. 3 and 4), which contains radiopharmaceuticals. The vial 2 can be handled by a robotic manipulating clamp 12 to move into a vial container 21. The manipulating clamp 12 comprises an extension bar 13, which allows the manipulating clamp 12 to extend into the hermetic chamber 1 and serve as a tool for manual operation. Of course, the manipulating clamp 12 can be completely replaced by an automatic robotic arm.

In a side wall of the vial container 21, a radiopharmaceuticals level monitoring window 22 (see FIG. 3) is formed. A radiopharmaceuticals level monitoring device 4 (such as a charge-coupled device (CCD) based monitor) is arranged at a position adjacent to a position facing the radiopharmaceuticals level monitoring window 22 and the radiopharmaceuticals level monitoring device 4 is connected to a monitor display 41 or a computer device. When a radiopharmaceuticals supply tube 20 supplies radiopharmaceuticals into the vial 2, the monitor display 41 monitors the level of the radiopharmaceuticals. When the radiopharmaceuticals inside the vial 2 reaches a predetermined level, the radiopharmaceuticals supply tube 20 is removed.

After the vial 2 is filled with radiopharmaceuticals, a dosage calibration process is carried out, as illustrated in FIG. 3. During this process, the robotic manipulating clamp 12 moves the vial 2 from the vial container 21 to a dosage calibration container 24. After the vial 2 is positioned in the dosage calibration container 24, the robotic manipulating clamp 12 holds and lifts a T-shaped handle bar 241 of the dosage calibration container 24 to move the dosage calibration container 24, together with the vial 2, into a dosage calibrator 3. The dosage calibrator 3 functions to measure the radioactivity of the radiopharmaceuticals contained in the vial 2.

Referring to FIG. 4, after the dosage calibration process is completed, the robotic manipulating clamp 12 is employed to move the dosage calibration container 24 and the vial 2 back to the original position of dosage calibration container 24. The robotic manipulating clamp 12 then holds a neck of the vial 2 and retrieves the vial 2 from the dosage calibration container 24 and moves the vial 2 to the vial container 21 in order to perform subsequent radiopharmaceuticals withdrawal and dispensing processes.

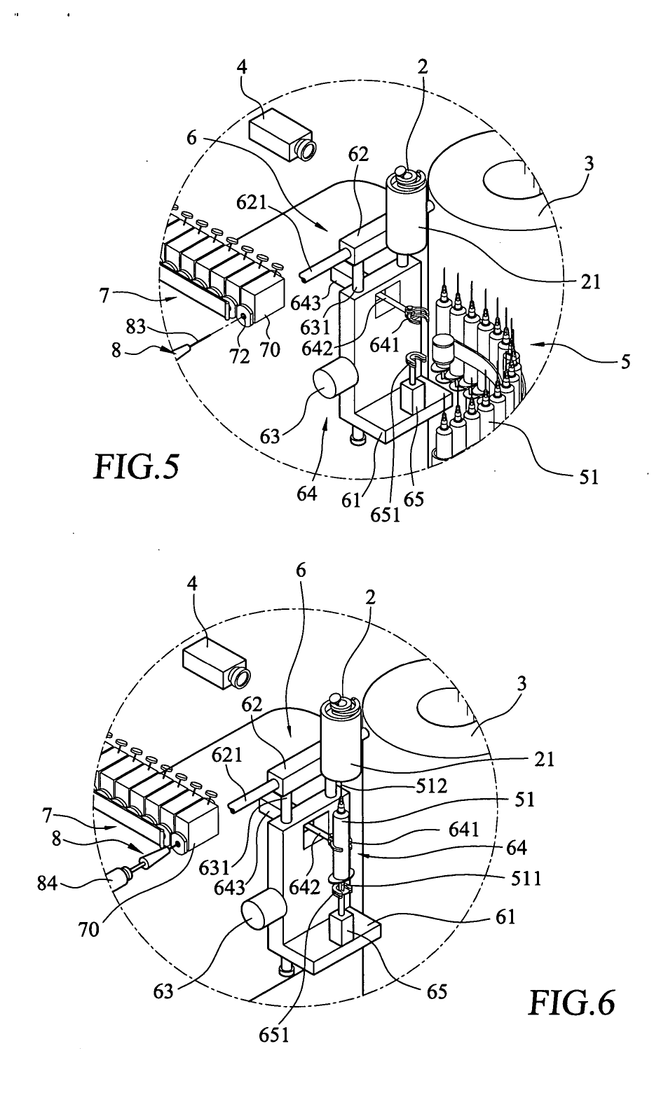

Referring to FIG. 5, inside the radiation-shielded hermetic chamber 1, disposed at a position adjacent to a bottom of the vial container 21 is a disposable syringe module 5, which comprises a plurality of disposable syringes 51 arranged in a line.

A movable dispensing and injection mechanism 6 is arranged inside the radiation-shielded hermetic chamber 1 at a position adjacent to the disposable syringe module 5 and the vial container 21 for controlling radiopharmaceuticals dispensing operation of a selected one of the disposable syringes 51 and for controlling movement of the selected disposable syringe 51 between a radiopharmaceuticals dispensing position and an injection position.

Referring to FIGS. 5 and 6 simultaneously, the movable dispensing and injection mechanism 6 comprises a support carrier 61, a horizontal transportation mechanism 62, a vertical transportation mechanism 63, a clamping and releasing mechanism 64, and a plunger driving mechanism 65. The horizontal transportation mechanism 62 moves the support carrier 61 in a horizontal direction along at least one horizontal rail 621 and the vertical transportation mechanism 63 moves the support carrier 61 in a vertical direction along at least one vertical rail 631.

The clamping and releasing mechanism 64 comprises a pick-up arm 641, an extension bar 642, and a clamping and releasing controller 643 for controlling the operation of clamping and/or releasing a selected one of the disposable syringes 51. When the extension bar 642 is driven by the clamping and releasing controller 643 to extend outward, the pick-up arm 641 is opened to pick up one disposable syringe 51 (as shown in FIG. 6).

The plunger driving mechanism 65 can be a motor and a pneumatic cylinder, which is mounted on the support carrier 61 for driving an upward pushing operation and/or a downward radiopharmaceuticals withdrawal operation of a plunger 511 of the selected disposable syringe 51. The plunger driving mechanism 65 may further comprise a pressure sensor 651 for detecting the pressure applied to the plunger 511 of the disposable syringe 51.

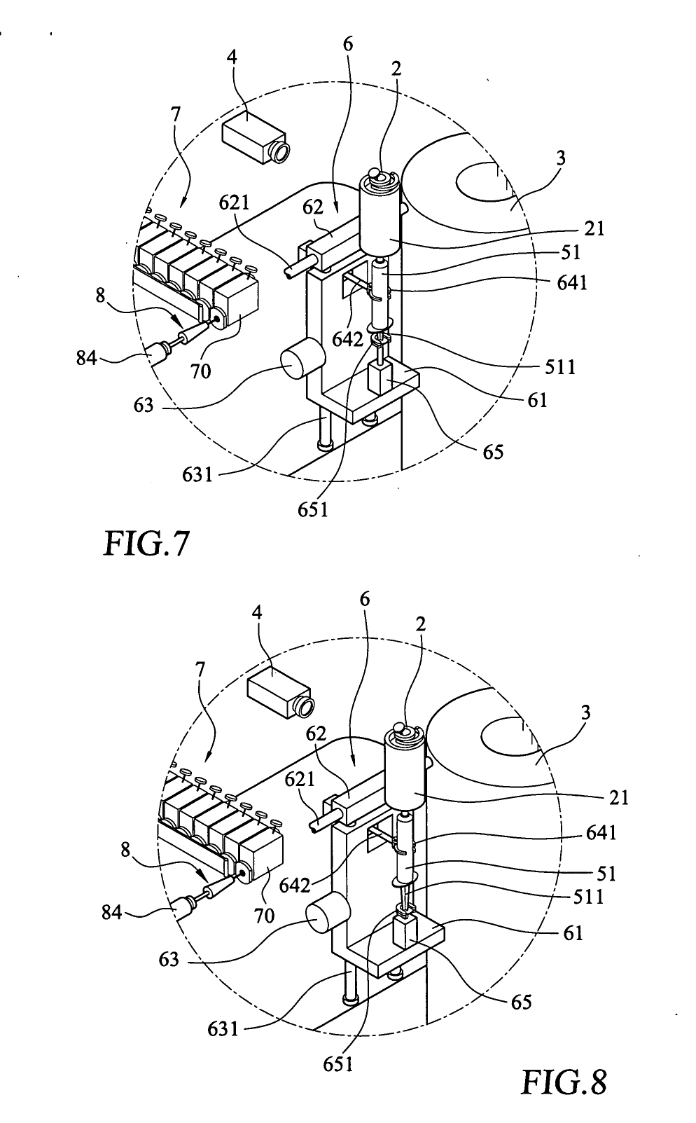

Once the selected disposable syringe 51 is held by the pick-up arm 641, which moves back to the original retreated position, the disposable syringe 51 is fixed in the radiopharmaceuticals dispensing position. At this time, the vertical transportation mechanism 63 drives the whole support carrier 61 to displace upwards along the vertical rail 631, thereby causing a needle 512 atop the disposable syringe 51 to penetrate into the bottom of the vial 2 (as shown in FIG. 7). Thereafter, under the driving and control of the plunger driving mechanism 65, the plunger 511 of the disposable syringe 51 is pulled downward (as illustrated in FIG. 8), whereby a predetermined amount of radiopharmaceuticals is withdrawn from the vial 2.

After the withdrawal operation of radiopharmaceuticals described above, the vertical transportation mechanism 63 causes the support carrier 61 to move downward along the vertical rail 631, which causes the disposable syringe 51 to displace downward and disengaging the needle 512 from the bottom of the vial 2. Thereafter, under the condition that the disposable syringe 51 is moved by being driven by the horizontal transportation mechanism 62, the disposable syringe 51 displaces to the injection position (that is a position adjacent to the injection needle insertion hole 11 of the radiation-shielded hermetic chamber 1).

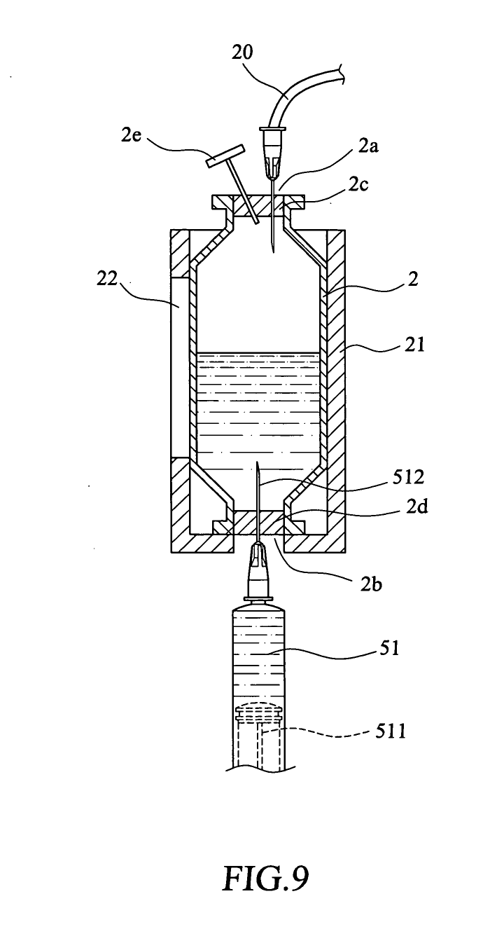

In a preferred embodiment of the present invention, the vial 2 has a two-open-end structure (referring to FIG. 9), wherein the main body of the vial 2 has a top opening 2a and a bottom opening 2b, in which a top plug body 2c and a bottom plug body 2d are fit respectively. Radiopharmaceuticals is supplied into the vial 2 by the radiopharmaceuticals supply tube 20 that extends through the top plug body 2c, while the needle 512 of the disposable syringe 51 can penetrate through the bottom plug body 2d for withdrawal of the radiopharmaceuticals contained in the via 2. The top plug body 2c of the top opening 2a of the vial 2 further comprise a filter 2e inserted therethrough whereby negative pressure may not be induced inside the vial 2 when the radiopharmaceuticals inside the vial 2 is withdrawn.

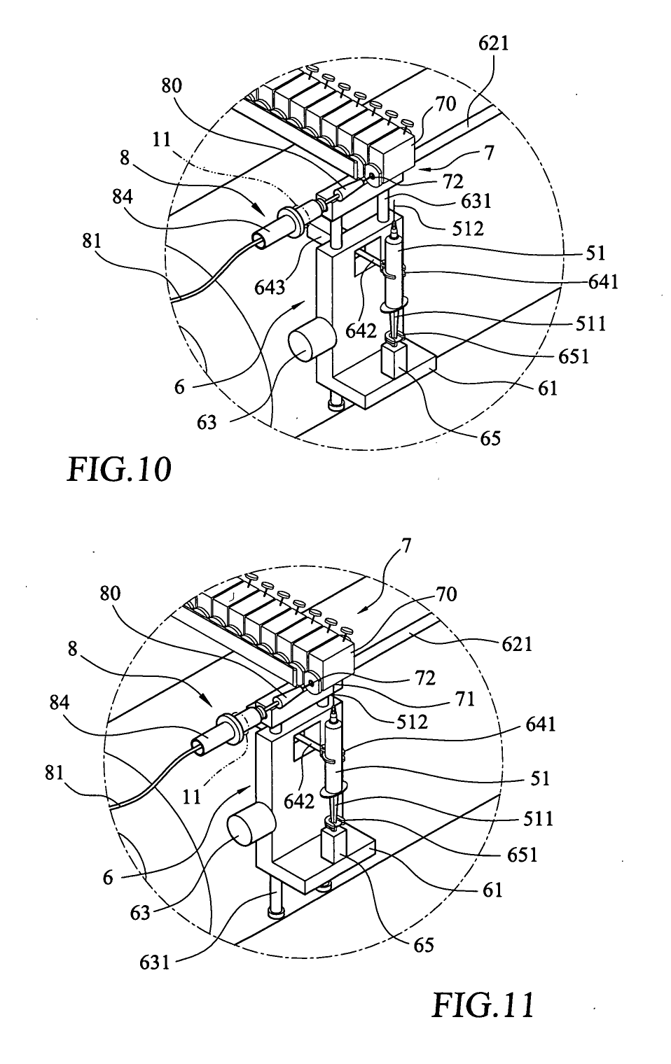

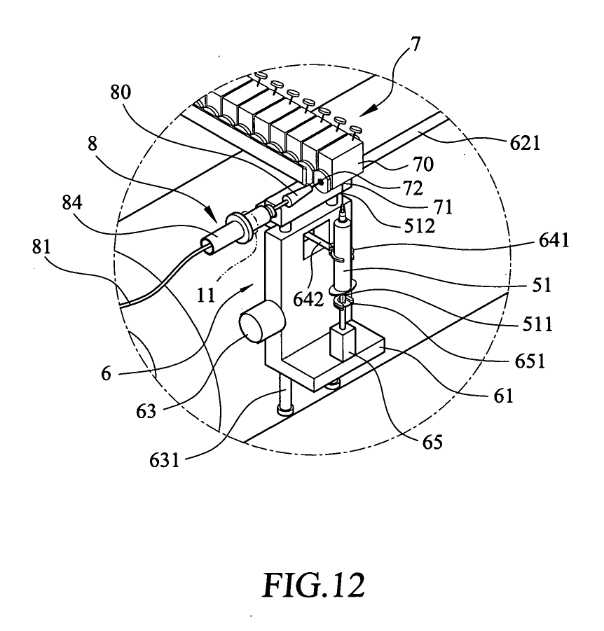

FIG. 10 shows an enlarged partial perspective view illustrating the condition when the disposable syringe 51 is driven by the horizontal transportation mechanism 62 of the movable dispensing and injection mechanism 6 to move to the injection position, but the needle 512 does not penetrate through a radiopharmaceuticals injection end 71 of the saline water cartridge 70. FIG. 11 shows an enlarged partial perspective view illustrating the condition when the disposable syringe 51 is located in the injection position and the needle 512 penetrates through the radiopharmaceuticals injection end 71 of the saline water cartridge 70. FIG. 12 shows an enlarged partial perspective view illustrating the condition when the disposable syringe 51 is located in the injection position, the needle 512 penetrates through the radiopharmaceuticals injection end 71 of the saline water cartridge 70, and the plunger 511 of the disposable syringe 51 is pushed upward.

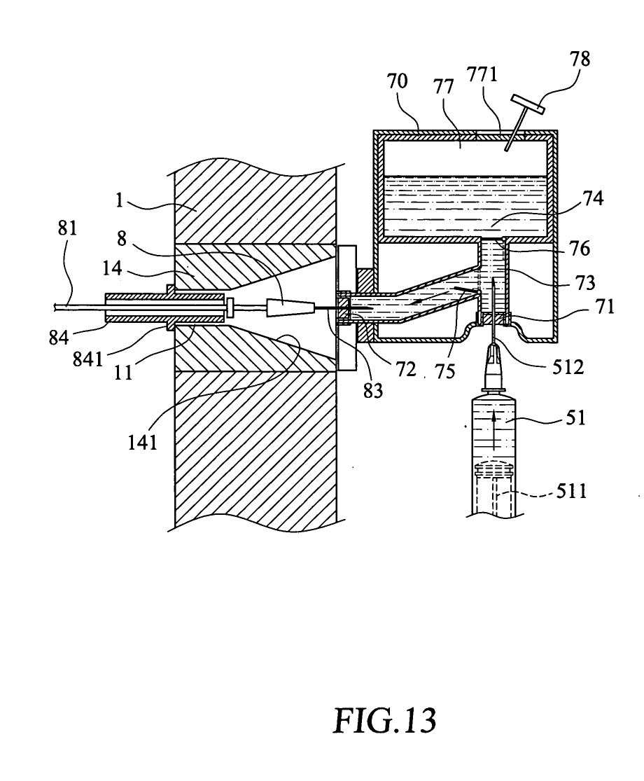

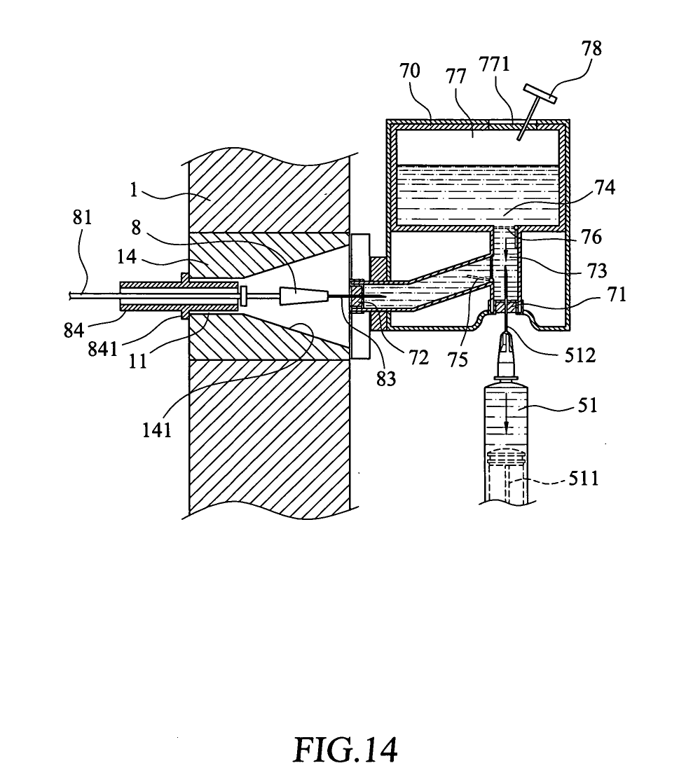

FIG. 13 shows a cross-sectional view illustrating the condition when the needle 512 of the disposable syringe 51 penetrates through the radiopharmaceuticals injection end 71 of the saline water cartridge 70 and the plunger 511 of the disposable syringe 51 is pushed upward. FIG. 14 shows a cross-sectional view illustrating the condition when the needle 512 of the disposable syringe 51 penetrates through the radiopharmaceuticals injection end 71 of the saline water cartridge 70 and the plunger 511 of the disposable syringe 51 is pulled downward. The saline water cartridge 70 is arranged inside the radiation-shielded hermetic chamber 1 at the injection position that is adjacent to the injection needle insertion hole 11.

As shown in FIGS. 13 and 14, a radiopharmaceuticals discharge end 72 of the saline water cartridge 70 allows for insertion of a needle 83 formed at a front end of an insertion section 8. The insertion section 8 has a rear end to which a tube 81 is connected. The tube 81 extends through the injection needle insertion hole 11 of the radiation-shielded hermetic chamber 1 and is connected to a needle 82 (also see FIG. 2) that is inserted into a patient's body.

At a suitable position of the tube 81, a conventional and rotation-operating three-way valve 811 (see FIGS. 1 and 2) is provided, having an end connected to the insertion section 8 by the tube 81 and another end connected through a terminal filter 812 to the patient needle 82. A saline water syringe 813 is inserted into a top face of the three-way valve 811 to fill the tube 81 with saline water before injection is performed, which avoids air existing in the tube 81 when injection is performed.

The structure of the saline water cartridge 70 comprises a radiopharmaceuticals injection end 71, a radiopharmaceuticals discharge end 72, an internal passage 73, and a saline water reservoir outlet end 74. A first one-way membrane valve 75 is arranged in the internal passage 73 at the radiopharmaceuticals discharge end 72 and a second one-way membrane valve 76 is arranged at the saline water reservoir outlet end 74.

The saline water cartridge 70 forms a saline water reservoir 77 therein, in which saline water is stored. The saline water reservoir 77 is connected to the internal passage 73 by the saline water reservoir outlet end 74 to allow the saline water to flow into the internal passage 73 of the saline water cartridge 70. The saline water reservoir 77 of the saline water cartridge 70 is provided with a penetrateable material layer 771, serving as a saline water injection end. The saline water contained in the saline water reservoir 77 can be filled into the saline water reservoir 77 before the penetrateable material layer 771 is closed, or alternatively, the saline water is filled into the saline water reservoir 77 by an injector penetrating through the penetrateable material layer 771 after the penetrateable material layer is closed. In addition, in practical application, an air filter 78 is inserted into the top face of the saline water reservoir 77 to prevent the induction of negative pressure inside the saline water reservoir 77 when the saline water inside the saline water reservoir 77 is withdrawn.

The needle 83 of the insertion section 8, when inserted into the radiopharmaceuticals discharge end 72 of the saline water cartridge 70, passes through the injection needle insertion hole 11 of the radiation-shielded hermetic chamber 1 to allow the needle 83 to penetrate through the radiopharmaceuticals discharge end 72 of the saline water cartridge 70.

To carry out penetration of the insertion section 8 into the radiopharmaceuticals discharge end 72 of the saline water cartridge 70, an auxiliary tube 84 is employed, which allows the needle 83 of the insertion section 8 to easily penetrate into the radiopharmaceuticals discharge end 72. A stop ring 841 is formed around a middle section of an outer circumferential surface of the auxiliary tube 84 to prevent the auxiliary tube 84 from dropping into the hermetic chamber 1 during the operation thereof and to set a predetermined depth of penetration for the needle 83.

To prevent radiation from emitting through the injection needle insertion hole 11 of the radiation-shielded hermetic chamber 1, an insert 14 made of tungsten material is inserted into the injection needle insertion hole 11. The insert 14 has an internal wall forming an inclined surface 141.

After the movable dispensing and injection mechanism 6 moves the disposable syringe 51 to the injection position (that is a position adjacent to the injection needle insertion hole 11 of the radiation-shielded hermetic chamber 1), the vertical transportation mechanism 63 drives the whole support carrier 61 to displace upward along the vertical rail 631, with which the needle 512 of the disposable syringe 51 is caused to penetrate through the radiopharmaceuticals injection end 71 of the saline water cartridge 70. Thereafter, the plunger 511 of the disposable syringe 51 is driven and controlled by the plunger driving mechanism 65 to displace and push upward whereby the radiopharmaceuticals that is previously withdrawn into and currently contained in the disposable syringe 51 is injected into the radiopharmaceuticals injection end 71 of the saline water cartridge 70.

At this moment, the first one-way membrane valve 75 of the saline water cartridge 70 is in an open condition, while the second one-way membrane valve 76 is in a closed condition (as shown in FIG. 13). Thus, radiopharmaceuticals can be fed from the internal passage 73 to the radiopharmaceuticals discharge end 72 and supplied through the needle 83, the insertion section 8, the tube 81, the three-way valve 811, and the terminal filter 812 to the needle 82 inserted into the patient's body.

When the injection operation of the radiopharmaceuticals is completed, the plunger 511 of the disposable syringe 51 is driven and controlled by the plunger driving mechanism 65 to move downward for carrying out at least one flushing cycle. At this moment, the first one-way membrane valve 75 of the saline water cartridge 70 is in a closed condition, while the second one-way membrane valve 76 is in an open condition (as shown in FIG. 14). Thus, saline water inside the saline water reservoir outlet end 74 can be withdrawn by the disposable syringe 51 through the saline water reservoir outlet end 74 and the radiopharmaceuticals injection end 71.

After the withdrawal operation of the saline water, the disposable syringe 51 is driven by the plunger driving mechanism 65 to push upward again and the saline water is injected into the radiopharmaceuticals injection end 71 of the saline water cartridge 70. At this moment, the first one-way membrane valve 75 of the saline water cartridge 70 is in an open condition, while the second one-way membrane valve 76 is in a closed condition (as shown in FIG. 13). Thus, the saline water is allowed to flow through the internal passage 73 to the radiopharmaceuticals discharge end 72 and supplied through the needle 83, the insertion section 8, the tube 81, the three-way valve 811, and the terminal filter 812 to the needle 82 inserted into the patient's to thereby effect flushing of radiopharmaceuticals.

The needle 83 of the disposable insertion assembly 8, when inserted into the radiopharmaceuticals discharge end 72 of the saline water cartridge 70, extends through the injection needle insertion hole 11 of the radiation-shielded hermetic chamber 1 to allow the needle 83 to penetrate through the radiopharmaceuticals discharge end 72 of the saline water cartridge 70. In inserting the needle 83, the auxiliary tube 84 is employed to facilitate penetration of the needle 83 into the radiopharmaceuticals discharge end 72 of the saline water cartridge 70.

The radiation-shielded hermetic chamber 1 is also provided with a door 17, which is also made of radiation-shielding material, whereby access through the door is provided for maintenance. Opening the door also allows for replenishment supply of the disposable syringes 51 of the syringe supply module 5 and the saline water cartridges 70 of the saline water cartridge module 7.

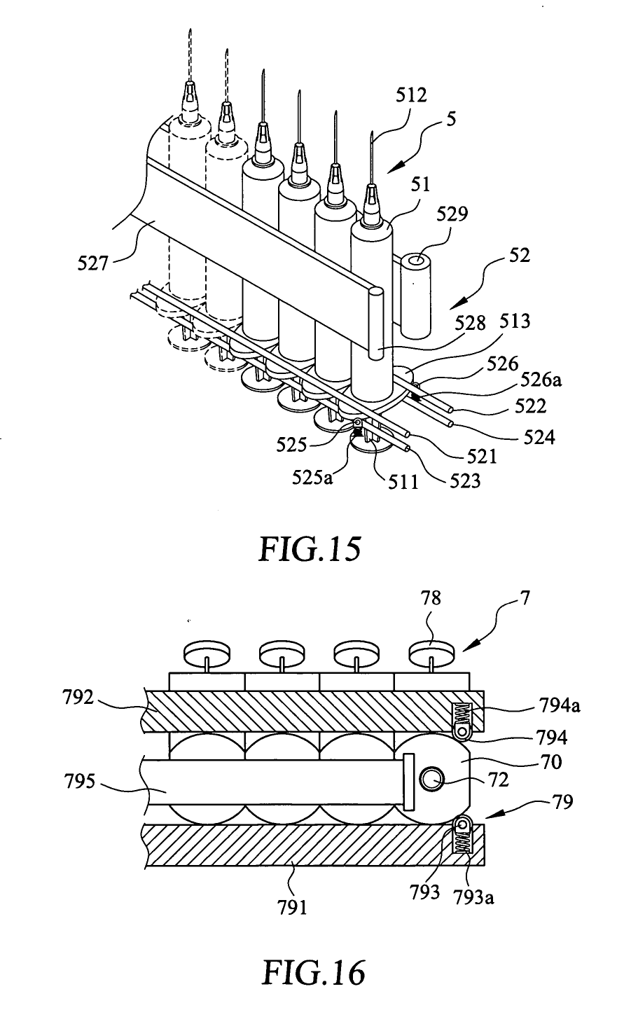

FIG. 15 shows a partial perspective view of a syringe feeding mechanism 52 for the syringe supply module 5 that constitutes in part the automatic feeding device for syringes and saline water cartridges of a radiopharmaceuticals injection system constructed in accordance with the present invention. As shown, a flange 513 of each disposable syringe 51 is held between and guided by a pair of upper guide bars 521, 522 and corresponding lower guide bars 523, 524. A pair of resilient stop elements 525, 526 is arranged at a position below the frontmost one of the disposable syringe 51. The pair of resilient stop elements 515, 526 is applied with an upward-directed resilient pushing force by a resilient element 525a, 526a. The resilient stop elements 525, 526 engage and stop the frontmost disposable syringe 51.

The whole set of disposable syringes 51 are provided with a forward-directed pushing force by a band 527. An end of the band 527 is fixed in a positioning pillar 527, while an opposite end is wound around a reel 529. Inside the reel 529, a conventional reeling mechanism is provided for applying a reeling force to the band 527 whereby the band 527 drives the whole set of disposable syringes 51 forward until the frontmost disposable syringe 51 is stopped by the resilient stop elements 525, 526.

When the pick-up arm 641 of the clamping and releasing mechanism 64 of the movable dispensing and injection mechanism 6 extends and opens to grasp the frontmost disposable syringe 51, the frontmost disposable syringe 51 is clamped and removed from the position between the upper guide bars 521, 522 and the corresponding lower guide bars 523, 524 for feeding of the desired syringe. After the frontmost disposable syringe 51 is removed, the next disposable syringe 51 is driven forward until stopped by the resilient stop elements 525, 526, thereby getting ready for next pick-up operation by the pick-up arm 641.

FIG. 16 shows a cross-sectional view of a saline water cartridge feeding mechanism 79 in accordance with the present invention, which has a construction similar to the syringe feeding mechanism 52 of the syringe supply module 5 illustrated in FIG. 15. As shown, each saline water cartridge 70 of the saline water cartridge module 7 is held and guided by a pair of guide boards 791, 792. A pair of resilient stop elements 793, 794 is arranged on the guide boards 793, 794 at a position adjacent to the frontmost one of the saline water cartridges 70. The resilient stop elements 793, 794 are applied with upward-directed and downward-directed resilient pushing forces by resilient elements 793a, 794a. The resilient stop elements 793, 794 engage and stop the frontmost saline water cartridge 70.

The whole set of saline water cartridges 70 is provided with a forward-directed pushing force by a band 795 that has a structure similar to the band of FIG. 15. An end of the band 795 is fixed in a positioning pillar, while an opposite end is wound around a reel. Thus, the band 795 drives the whole set of saline water cartridges 70 forward until the frontmost saline water cartridge 70 is stopped by the resilient stop elements 793, 794.

When the pick-up arm 641 of the clamping and releasing mechanism 64 of the movable dispensing and injection mechanism 6 applies an outward driving force to the disposable syringe 51, if the driving force is greater than the retaining force induced by the resilient stop elements 793, 794, the frontmost saline water cartridge 70 is forcibly disengaged from the retention of the resilient stop elements 793, 794 whereby the frontmost saline water cartridge 70 is moved out along the guide boards 791, 792. At this moment, the next saline water cartridge 70 is pushed forward until stopped by the resilient stop elements 793, 794.

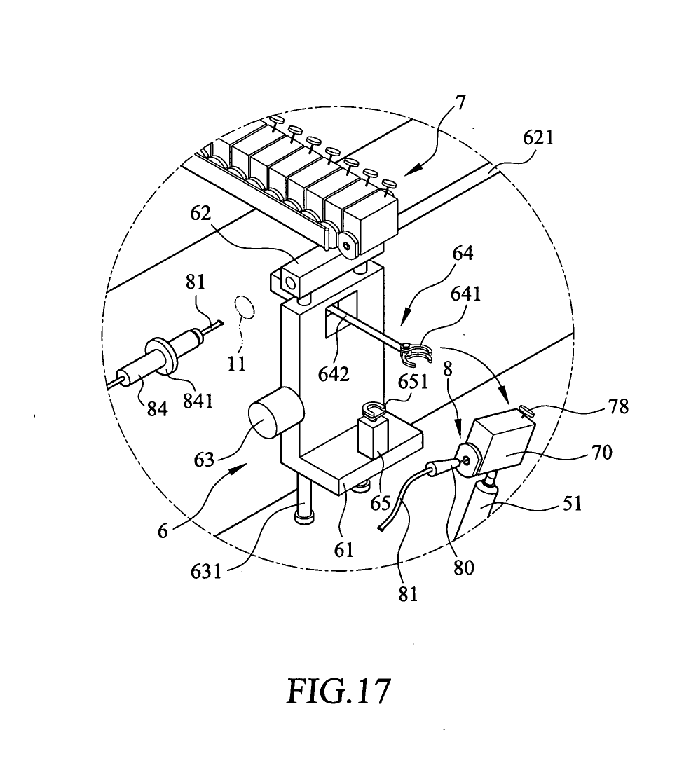

Referring to FIG. 17, after the injection and flushing operations are completed, the auxiliary tube 84 is removed from the injection needle insertion hole 11. The tube 81 is cut off at a position between the auxiliary tube 84 and the injection needle insertion hole 11 with thermal fusion means, which forms a thermally fused sealing structure at the cut off portion to keep radiopharmaceuticals remaining in the tube 81 from leaking outward. Thereafter, the pick-up arms 641 of the clamping and releasing mechanism 64 of the movable dispensing and injection mechanism 6 extends and opens to release and thus dispose the used saline water cartridge 70, a portion of the tube 81, and the disposable insertion assembly 8 into a bottom container (not shown) inside the radiation-shielded hermetic chamber 1.

Although the present invention has been described with reference to the preferred embodiment thereof, it is apparent to those skilled in the art that a variety of modifications and changes may be made without departing from the scope of the present invention which is intended to be defined by the appended claims.

1. An automatic feeding device for syringes and saline water cartridges of radiopharmaceuticals dispensing and injection system, which serves to automatically feed syringe and saline water cartridge inside a chamber, the automatic feeding device comprising:
a vial containing radiopharmaceuticals therein and located in a dispensing position inside the chamber;
a syringe supply module arranged inside the chamber, comprising a plurality of syringes arranged in a line;
a syringe feeding mechanism for picking up one disposable syringe from the syringe supply module at each time and feeding the syringe to a predetermined dispensing position inside the chamber;
a saline water cartridge module arranged inside the chamber, comprising a plurality of saline water cartridges arranged in a line;
a saline water feeding mechanism for picking up one saline water cartridge from the saline water cartridge module at each time and feeding the saline water cartridge to a predetermined injection position inside the chamber;
a movable dispensing and injection mechanism for clamping the disposable syringe fed by the syringe feeding mechanism and performing radiopharmaceuticals withdrawal/dispensing operation at the dispensing position to withdraw radiopharmaceuticals from the vial, and moving the disposable syringe from the dispensing position to the injection position and injecting the withdrawn radiopharmaceuticals into the saline water cartridge fed by the saline water cartridge feeding mechanism at the injection position.

2. The automatic feeding device for syringes and saline water cartridges of radiopharmaceuticals dispensing and injection system as claimed in claim 1, wherein the movable dispensing and injection mechanism comprises:
a support carrier;
a horizontal transportation mechanism which drives the support carrier in a horizontal direction along a horizontal rail;
a vertical transportation mechanism which drives the support carrier in a vertical direction along a vertical rail;
a clamping and releasing mechanism for clamping and releasing a disposable syringe fed by the syringe feeding mechanism; and
a plunger driving mechanism mounted on the support carrier for driving a plunger of the disposable syringe to displace upward and to withdraw radiopharmaceuticals from the vial.

3. The automatic feeding device for syringes and saline water cartridges of radiopharmaceuticals dispensing and injection system as claimed in claim 2 further comprising a pressure sensor arranged below the plunger driving mechanism for detecting pressure applied to the plunger of the disposable syringe.

4. The automatic feeding device for syringes and saline water cartridges of radiopharmaceuticals dispensing and injection system as claimed in claim 1, wherein the saline water cartridge comprises a disposable insertion assembly, which extends through an injection needle insertion hole of the chamber and penetrates through a radiopharmaceuticals discharge end of the saline water cartridge to discharge saline water and radiopharmaceuticals contained in the selected saline water cartridge through the radiopharmaceuticals discharge end.

5. The automatic feeding device for syringes and saline water cartridges of radiopharmaceuticals dispensing and injection system as claimed in claim 4, wherein the disposable insertion assembly comprises:
an insertion section having a front end to which a needle is mounted and a rear end forming a rear end face;
a tube having an end connected to the needle and an opposite end connected to a needle adapted to insert into a patient's body; and
an auxiliary tube abutting against a rear end face of the insertion section;
wherein the needle at the front end of the insertion section is inserted into the radiopharmaceuticals discharge end of the saline water cartridge by extending through the injection needle insertion hole with the auxiliary tube abutting against the rear end face of the insertion section.

6. The automatic feeding device for syringes and saline water cartridges of radiopharmaceuticals dispensing and injection system as claimed in claim 5, wherein the auxiliary tube forms a stop ring around a middle section of an outer circumferential surface thereof.

7. The automatic feeding device for syringes and saline water cartridges of radiopharmaceuticals dispensing and injection system as claimed in claim 4, wherein a radiation-shielding ring made of tungsten material is fit into the injection needle insertion hole of the chamber.

8. The automatic feeding device for syringes and saline water cartridges of radiopharmaceuticals dispensing and injection system as claimed in claim 1, wherein the syringe feeding mechanism comprises:
a pair of upper guide bars and corresponding lower guide bars for holding and guiding a flange of each disposable syringe;
a pair of resilient stop elements arranged at a position adjacent to a bottom of a frontmost one of the disposable syringes to provide an upward-directed resilient pushing force, the resilient stop elements stopping the frontmost disposable syringe; and
a band applying a forward-directed pushing force acting on the whole set of disposable syringes to drive the whole set of disposable syringes forward until the frontmost disposable syringe is stopped by the resilient stop elements.

9. The automatic feeding device for syringes and saline water cartridges of radiopharmaceuticals dispensing and injection system as claimed in claim 1, wherein the saline water cartridge feeding mechanism comprises:
a pair of guide boards for holding and guiding each saline water cartridge;
a pair of resilient stop elements arranged at a position adjacent to a frontmost one of the saline water cartridges to provide upward-directed and downward-directed resilient pushing forces, the resilient stop elements stopping the frontmost saline water cartridge; and
a band applying a forward-directed pushing force acting on the whole set of saline water cartridges to drive the whole set of saline water cartridges forward until the frontmost saline water cartridge is stopped by the resilient stop elements.
